(19) United States
(12) Patent Application Publication
(10) Pub. No.: US 2007/0217888 A1
(43) Pub. Date: Sep. 20, 2007

(54) Double-shank shooting nail

(75) Inventor: Pan-Ching Huang, Hsienhsi Shiang (TW)

Correspondence Address: BRUCE H. TROXELL, SUITE 1404, 5205 LEESBURG PIKE, FALLS CHURCH, VA, 22041, US

(73) Assignee: Joker Industrial Co., Ltd.

(21) Appl. No.: 11/377,308

(22) Filed: Mar. 17, 2006

(51) Int. Cl. F16B 15/08

(52) U.S. Cl. 411/442

(57) ABSTRACT

A double-shank shooting nail includes a master nail and a sub-nail on the master nail to enhance fastening. The master nail has a master shank with an action portion. The action portion has at least one jutting flange. The flange has at least one notch formed on a corresponding longitudinal location to become a sub-nail holding trough to hold at least one sub-nail. The sub-nail has a coupling portion on the top end to be coupled on the surface of the master shank and a sloped surface on the tip, and at least one notch on the outer surface thereof. When the master shank is nailed into a metal board, the metal board is wedged between two neighboring flanges, and the sub-nail is bent and inserted into a spacer. The sub-nail may be hardened by a hardening process in advance so that the master nail and the sub-nail can penetrate through the metal board to enhance fastening without loosening.

### BACKGROUND OF THE INVENTION

1. Field of the Invention

The invention relates to a double-shank shooting nail and particularly to a double-shank shooting nail that has a sub-nail located on a master nail to provide an enhanced fastening.

2. Description of the Prior Art

Referring to FIG. 1, a conventional shooting nail 5 is nailed to fasten a spacer 6 and a metal board 7 together. The shooting nail 5 has a shank 50 with screw threads on the outer surface that are mostly formed at the same dimension. It does not have any reinforced design to aid fastening. Hence after the shooting nail 5 is nailed, it is prone to shake. This affects the coupling firmness of the spacer 6 and the metal board 7. And the spacer 6 and the metal board 7 tend to loosen and separate.

### SUMMARY OF THE INVENTION

In view of the aforesaid problems, the primary object of the present invention is to provide a double-shank shooting nail that can provide an enhanced fastening. It includes a master nail and at least one sub-nail. The master nail has a master shank with an action portion. The action portion has at least one flange formed on the outer surface. The flanges are spaced at an interval equal to or slightly smaller than the thickness of a metal board to be nailed. When the master nail is nailed into the metal board, the metal board is confined between two neighboring flanges.

In one aspect of the invention, the flange of the master nail has at least one notch formed on a same corresponding longitudinal location to form at least one holding trough to hold the sub-nail. The sub-nail has a top end with a coupling portion to be coupled with the master shank surface.

In another aspect of the invention, the sub-nail has a sloped surface on the tip, and a notch formed on the outer surface of a secondary shank.

In yet another aspect, the diameters of the flanges on the action portion of the master nail decrease gradually from the upper side towards the lower side to provide a firmer fastening after nailing into the board.

In still another aspect, the lower portion of the sub-nail is not coupled with the master nail. And the sub-nail and the master nail are positioned vertically in a juxtaposed manner. When the double-shank shooting nail is nailed into the metal board through the spacer, the master nail which has a greater hardness penetrates through the metal board, while the sub-nail which has a lower hardness is bent outwards due to the sloped surface at the tip and the notch on the secondary shank that reduces the strength. As the master nail has an inertial force during nailing, the sub-nail is easily bent and nails into the spacer to form a stronger fastening for the spacer and the metal board.

The flange may be formed by a screw thread extending from the master shank surface and formed in a diagonal V-shape cross section.

The sub-nail may have a greater hardness through a hardening process so that both the master nail and sub-nail can penetrate the metal board during nailing to enhance fastening.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional shooting nail.

FIG. 2 is an exploded view of the invention.

FIG. 3 is a perspective view of the invention.

FIG. 4 is a plane view of the invention.

FIG. 5 is a cross section of the invention.

FIG. 6 is a schematic view of an embodiment of the invention.

FIG. 7 is a schematic view of another embodiment of the invention.

FIG. 8 is a schematic view of yet another embodiment of the invention

FIG. 9 is a schematic view of an embodiment of the invention used on a spacer of varying thickness.

FIG. 10 is a schematic view of another embodiment of the invention used on a spacer of varying thickness.

### DESCRIPTION OF THE PREFERRED EMBODIMENTS

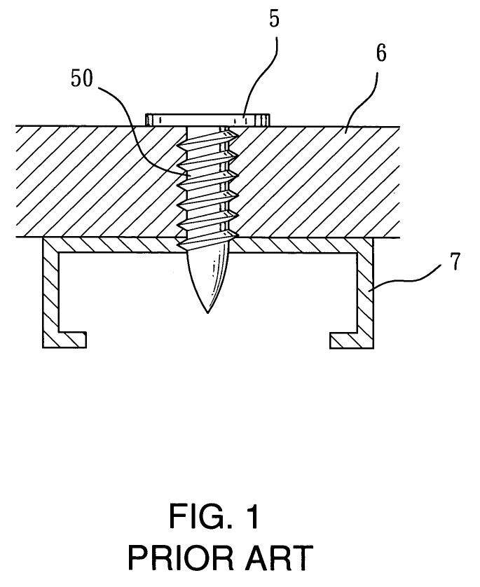

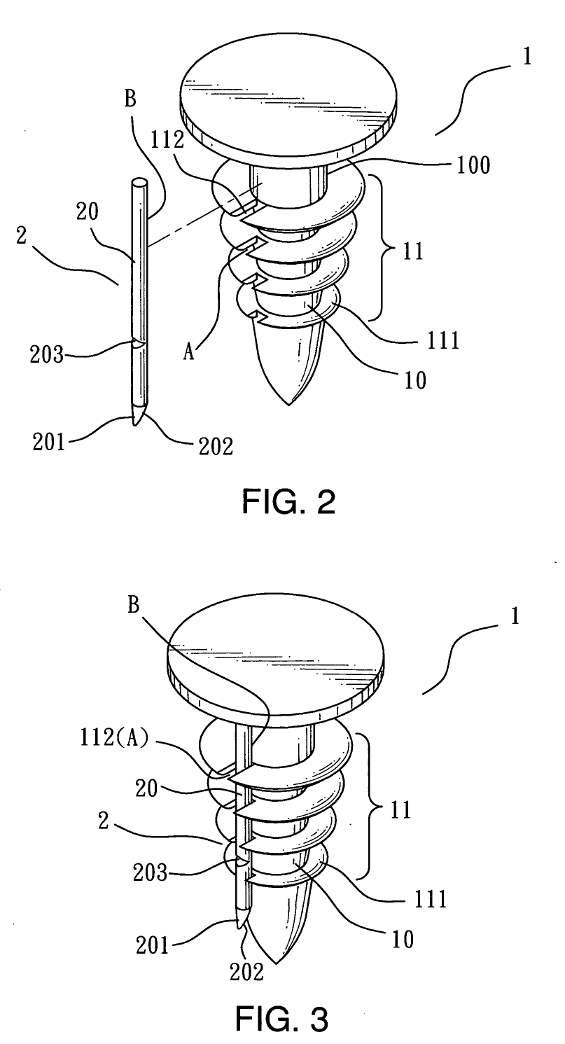

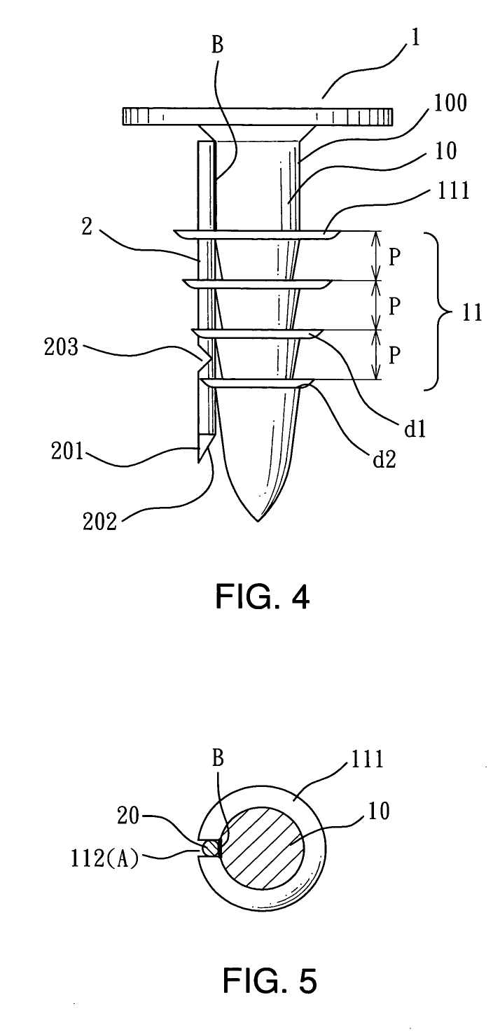

Referring to FIGS. 1 through 4, the invention includes a master nail 1 and at least one sub-nail 2. The master nail 1 has a master shank 10 which has an action portion 11. The action portion 11 has at least one flange 111 formed on the shank surface 100 thereof. The flanges 111 are spaced from each other at an interval P which is equal to or slightly smaller than the thickness T of a metal board 3 to be nailed. Each flange 111 further has at least one notch A formed on a same corresponding longitudinal position to form a sub-nail holding trough 112.

The sub-nail 2 has a secondary shank 20 which has a coupling portion B on the top end to be coupled with the shank surface 100 of the master nail 1, and a tip 20 which has a sloped surface 202, and a notch 203 formed on an outer surface thereof to reduce the strength of the sub-nail 2.

On the structure set forth above, the cross section of the flange 111 on the action portion 11 of the mater nail 1 may be formed in a screw thread or a diagonal V-shape. The surface on the interval P between the flanges 111 becomes a diagonal cone. Hence when the master shank 10 is nailed into the metal board 3, the metal board 3 is wedged between two neighboring flanges 111. As the upper diameter dl is greater than the lower diameter d2, namely the diameter of the flange 111 on the action portion 11 decreases gradually from the upper side towards the lower side, it can increase fastening strength and prevent loosening.

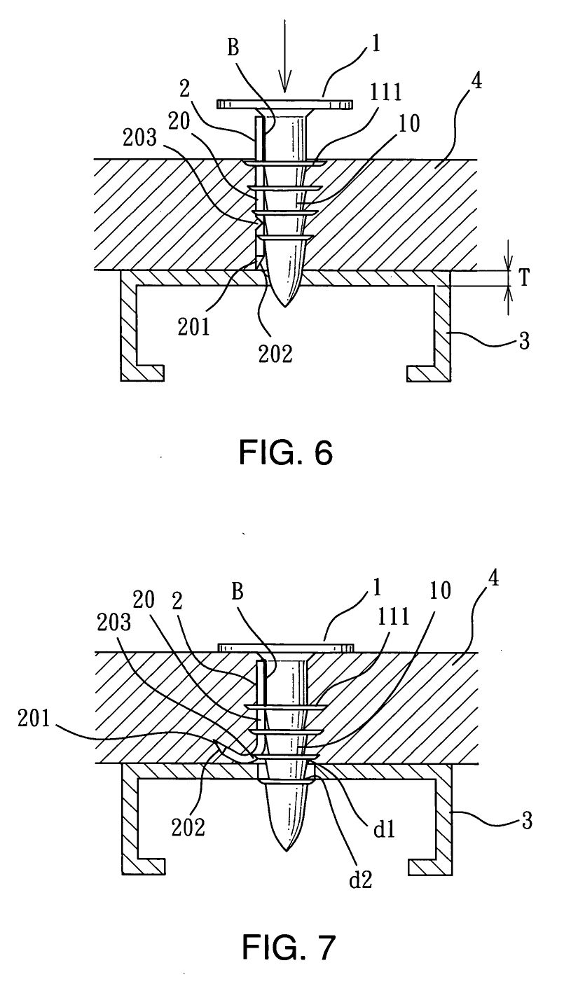

Referring to FIG. 6, the coupling portion B of the sub-nail 2 is coupled on the shank surface 100 of the master nail 1 to allow the sub-nail 2 to be held in the sub-nail holding trough 112 (also referring to FIG. 5) but without coupling the lower portion of the sub-nail 2 with the master nail 1. The sub-nail 2 and master nail 1 are positioned vertically close to each other in a juxtaposed manner. When the double-shank shooting nail is nailed into a spacer 4 and the metal board 3, as the master nail 1 has a greater hardness than the metal board 3, it can penetrate through the metal board 3. But the sub-nail 2 has a lower hardness than the metal board 3, hence it is bent sideward. The sloped surface 202 on the tip 201 can channel the sub-nail 2 to skew and bend sideward. Moreover, the notch 203 on the outer surface of the secondary shank 20 further reduces the strength of the sub-nail 2, therefore the sub-nail 2 is easily directed sideward and inserted into the spacer 4 (as shown in FIG. 7). Thereby fastening of the spacer 4 and the metal board 3 is enhanced.

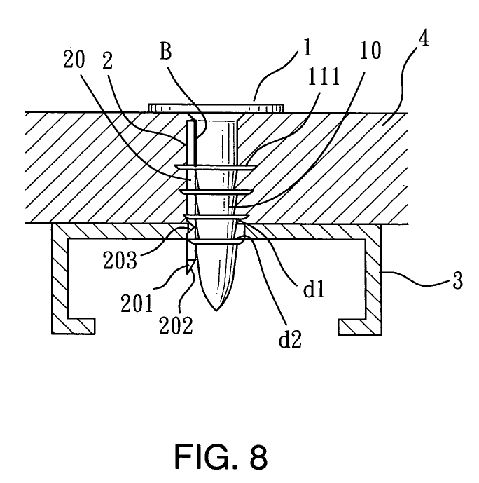

The hardness of the sub-nail 2 can be enhanced by a hardening process to be greater than that of the metal board 3. Then both the master nail 1 and the sub-nail 2 can be nailed at the same time and penetrate the metal board 3 (as shown in FIG. 8) to achieve a more secured fastening.

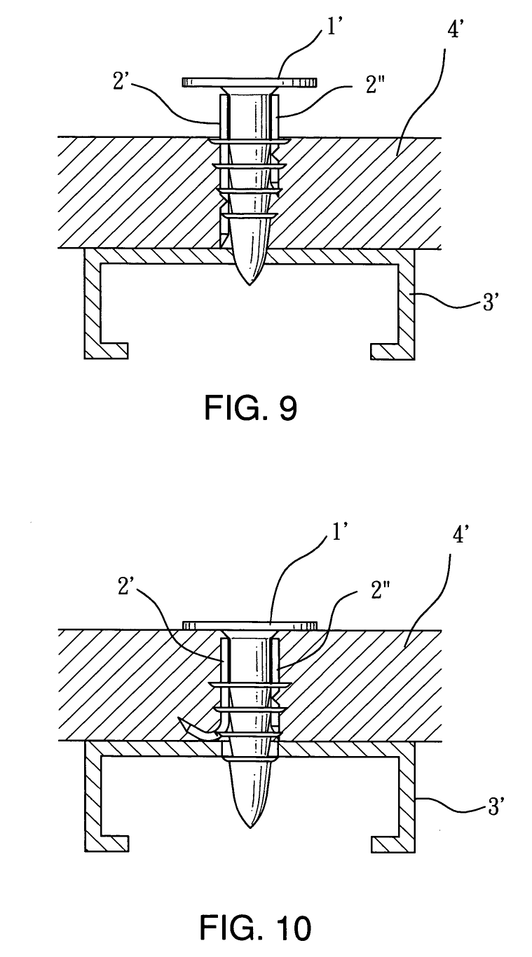

Referring to FIGS. 9 and 10, the invention may be used on spacers of varying thickness. Namely the master nail 1′ can be coupled with a plurality of sub-nails 2′ and 2″ of different lengths. Therefore when the spacer 4′ has a greater thickness, the sub-nail 2′ of a greater length can provide an enhanced fastening as shown in FIG. 7 by bending and penetrating into the spacer 4′. The sub-nail 2′ may also be hardened by a hardening process in advance so that it can penetrate the metal board 3 with the master nail 1′ to achieve a more secured fastening (same as the embodiment shown in FIG. 8).

I claim:

1. A double-shank shooting nail comprising a master nail and at least one sub-nail, wherein:
the master nail has a master shank which has an action portion, the action portion having at least one flange extended formed the surface of the mast shank; and
the sub-nail has a secondary shank which has a coupling portion coupled on the surface of the master shank.

2. The double-shank shooting nail of claim 1, wherein the action portion has at least one sub-nail holding trough formed by at least one notch on the flange on a corresponding longitudinal location.

3. The double-shank shooting nail of claim 1, wherein the flanges on the action portion are spaced from each other at an interval equal to or slightly smaller than the thickness of a metal board to be nailed.

4. The double-shank shooting nail of claim 1, wherein the flange is one ring of a screw thread extended from the surface of the master shank.

5. The double-shank shooting nail of claim 1, wherein the flange has a cross section formed in a diagonal V-shape.

6. The double-shank shooting nail of claim 1, wherein the sub-nail has a tip which has a sloped surface.

7. The double-shank shooting nail of claim 1, wherein the sub-nail has a notch formed on an outer surface thereof.

8. The double-shank shooting nail of claim 1, wherein the master nail has a greater hardness than a metal board to be nailed.

9. The double-shank shooting nail of claim 1, wherein the coupling portion of the sub-nail is coupled on the surface of the master shank, the sub-nail and the master nail being close to each other vertically in a juxtapose manner.
